(19) United States
(12) Patent Application Publication
(10) Pub. No.: US 2003/0235182 A1
(43) Pub. Date: Dec. 25, 2003

(54) Virtual key system

(76) Inventor: Rick McMullin, Ottawa (CA)

Correspondence Address: DOWELL & DOWELL PC, SUITE 309, 1215 JEFFERSON DAVIS HIGHWAY, ARLINGTON, VA, 22202

(21) Appl. No.: 10/175,808

(22) Filed: Jun. 21, 2002

(51) Int. Cl. H04L 12/66; H04L 12/28

(52) U.S. Cl. 370/352; 370/401; 370/400

(57) ABSTRACT

A virtual key system is provided for giving small businesses access to network-based call features on a converged voice and data network. Call management and call feature functionality are provided on a Telephony Application Server (TAS) located on the premises of a service provider. The TAS performs call management functions such as translating dialled digits into IP addresses, and call feature functions such as call forwarding. Calls are routed through an IP/PSTN gateway and a traditional class 5 switch after consulting the TAS. The virtual key system allows the customer to have access to PBX-like features without having to purchase or maintain a PBX. The system also allows the service provider to provide such services while provisioning as few as a single directory number for the customer, and to customize services offered to the customer.

### FIELD OF THE INVENTION

The present invention relates to telecommunication systems, and in particular to telecommunication systems for delivering telephony and communication management services from a service provider's network to an end user's local devices.

### BACKGROUND OF THE INVENTION

The convergence of voice and data traffic on a single broadband network has given rise to significant opportunities in the telecommunications industry. The convergence allows Voice over Internet Protocol calls, in which voice signals are packetized and transmitted within a Local Area Network (LAN) of a business site, and to other sites over a public packet network such as a metro packet network or the Internet. This allows for inexpensive long distance communications. Within a business site, it also allows the unification of a voice network and a data network into a single LAN, thereby reducing capital and maintenance costs. A service provider (such as a local exchange carrier) can more easily provide both voice and data services to its customers.

This convergence also allows for improved delivery of call features, such as caller ID and call transfer. In traditional communication (i.e. non-converged) systems, call feature signals for initiating and providing call features are carried by the same channel as is used to carry voice signals. In converged systems call feature signals are packetized, thereby allowing for more detailed call feature signalling and easier introduction of new or customized call features.

Businesses commonly use a Private Branch Exchange (PBX) or a key system to perform call management tasks. The PBX allows end users in the business to telephone each other by dialling extension numbers (telephone numbers made up of two, three or four digits), instead of the full seven or ten digit telephone number normally associated with a called station (known as National Numbering Plan (NPA-NNP) format). The PBX also provides call features, such as auto attendant and call forwarding. The PBX is typically owned and operated by the business. In a converged communication system, such a PBX must be able to handle packetized data, including packetized voice traffic.

One solution is an IP PBX. An IP PBX is a voice and data switching system located at a business site that switches voice calls to and from extensions at the site. However, while relatively large enterprise customers have to date been realizing the benefits of IP PBX systems, small businesses have not. This is because such systems are often too expensive for the small business owner. As well, dealers it and value-added resellers cannot afford to sell to the small business customer because they cannot make sufficient margin on selling, installing and servicing equipment. As a result of these barriers, the small business customer has been under served and overcharged in this market.

Call features can also be delivered to a business site from a service provider's site. The call features are provided over a broadband network from equipment that is network-based, rather than customer-based. By contrast with IP PBX, IP Centrex provides customers with the call features of a PBX without the need to purchase and maintain a PBX. The equipment providing the call control and service logic functions for IP Centrax is owned and operated by a service provider (typically a Local Exchange Carrier) and hence is located on the service provider's premises. Two architectures are possible in IP Centrex systems: a class 5 switch architecture and a softswitch architecture.

While IP Centrex can have benefits over IP PBX from the perspective of the small business owner, IP centrex suffers from its own drawbacks and limitations. In a class 5 switch architecture, a single directory number must be provisioned on the class 5 switch for each end user device (e.g. IP telephone set or personal computer) for which external communication is to be provided by the service provider. Furthermore, new class 5 switching features take years to develop and are often released to all service providers simultaneously, limiting the ability of a service provider to differentiate its services from those of its competitors. This is further aggravated by incorporation of business communication services into class 5 switches, which often precludes a service provider from offering any additional services that are not offered by the class 5 switch vendor.

While a softswitch architecture does not require the provisioning of a directory number for each end user device, it involves the replacement of a class 5 switch. This can be expensive for a service provider providing voice and data services to small business customers. Furthermore softswitches have only recently becomes available in the marketplace and current softswitches support only a relatively small set of call processing features.

Another solution for the delivery of call features to a business is Voice over Digital Subscriber Line (VoDSL). This architecture makes use of a VoDSL gateway connected to a class 5 switch to deliver several voice channels over a DSL broadband connection. The VoDSL gateway communicates with the class 5 switch using GR-303. The VoDSL gateway mimics a Digital Loop carrier and makes use of a special Integrated Access Device (IAD) at the customer premises to respond to events that are generated by the class 5 switch and passed through the VoDSL gateway. In this architecture the VoDSL gateway is simply acting as a pass-through for events that are generated at the class 5 switch or at the IAD. However, as with IP Centrex implemented with a class 5 switch architecture, there is still a single directory number provisioned on the class 5 switch for every and user device that is used by a small business.

A need therefore exists for a key system to provide call management services and call features to business customers over data networks in a manner that combines the directory number concentration of an IP PBX with the network capabilities of IP Centrex and VoDSL.

### SUMMARY OF THE INVENTION

The invention provides a system for providing call management services and call features to a plurality of end user devices on a Local Area Network (LAN) within a customer premises, the LAN being in communication with the system through a packet switched broadband network. The system includes a packet network; an access switch coupled to the packet network and adapted to be coupled to the packet switched broadband network; an Internet Protocol (IP)/Public Switched Telephone Network (PSTN) gateway coupled to the packet network; a traditional class 5 switch coupled to the IP/PSTN gateway and providing access to a PSTN, and having at least one directory number provisioned for the customer premises, there being fewer such directory numbers than end user devices; and a Telephony Application Server (TAS) including an automated attendant and coupled to the packet network, and adapted to provide the call management services and the call features to the end user devices. There may be only one directory number provisioned for the customer premises. The IP/PSTN gateway and the class 5 switch may communicate through a primary rate interface.

In one embodiment, the call features include audio call features, and the TAS includes a database adapted to store user information; a media server adapted to provide the audio call features to the end user devices; and a Call Processor adapted to provide the call management services and the call features to the end user devices. The Call Processor may include a presentation layer for presenting the call management services and the call features to the end user devices; a support layer for providing access to the database and to hardware devices; and a business layer. The business layer includes a service environment framework for providing shared services to a call; a call control framework for managing calls; a device management framework for providing communication between the service environment framework and the support layer; a routing framework for collecting and translating dialled digits, and for routing a call to a called device; a connections framework for maintaining a representation of an audio state of a call; and a run-time system framework for scheduling and managing software tasks within the TAS. The support layer may further include a device abstraction layer for abstracting communications between the TAS and the end user devices and between the TAS and the IP/PSTN gateway.

In another embodiment the TAS includes at least one web application including a customer administration application for allowing an authorized end user to perform customer configuration tasks. As other web applications, the TAS may include a user portal for allowing end users to configure the end user devices and to access call features; a service provider administration application for allowing an administrator of the system to configure and monitor the system; and a third-party services interface for allowing a third party to add call features to the system.

In yet another embodiment the call features include audio call features, and the TAS includes a first hardware platform having a database adapted to store user information; a second hardware platform having a media server adapted to provide the audio call features to the end user devices; and a third hardware platform having a Call Processor adapted to provide the call management and the call feature services to the end user devices.

The invention also provides a Telephony Application Server (TAS) for providing call management services and call features, including audio call features, to a plurality of end user devices. The TAS includes a database adapted to store user information; a media server adapted to provide the audio call features to the end user devices, including an automated attendant; and a Call Processor adapted to provide the call management services and the call features to the end user devices.

In one embodiment, the Call Processor includes a presentation layer for presenting the call management services and the call features to the end user devices; a support layer for providing access to the database and to hardware devices; and a business layer. The business layer includes a service environment framework for providing shared services to a call; a call control framework for managing calls; a device management framework for providing communication between the service environment framework and the support layer; a routing framework for collecting and translating dialled digits, and for routing a call to a called device; a connections framework for maintaining a representation of an audio state of a call; and a run-time system framework for scheduling and managing software tasks within the TAS.

In another embodiment, the TAS includes at least one web application including a customer administration application for allowing an authorized end user to perform customer configuration tasks. The TAS may also includes as web applications a user portal for allowing end users to configure the end user devices and to access call features; a service provider administration application for allowing an administrator of the system to configure and monitor the system; and a third-party services interface for allowing a third party to add call features to the system.

The system of the present invention provides a virtual key system (including call management and call feature services) to customers. The system is network-based, and communicates with a converged network at a customer site over existing broadband connections. The customer need not purchase and maintain capital equipment, such as a PBX. Changes or upgrades to a customer's equipment are kept to a minimum when new services are added to the system. The system provides a hosted solution, thereby keeping costs to the customer predictable. In the embodiment in which the TAS includes web applications, end users can customize call feature settings and manage calls through a web-interface. Authorized end users can perform administrative functions through a web-interface, such as ordering new telephones or configuring existing telephones and users.

A service provider benefits by being able to provide a network-based key system without replacing an existing class 5 switch. The class 5 switch can be provisioned so as to use as few as one directory number for each customer, rather than requiring one directory number per end user device. Furthermore, the system can be customized or upgraded without requiring changes or upgrades to an existing class 5 switch.

Other aspects and features of the present invention will become apparent to those of ordinary skill in the art, upon review of the following description of specific embodiments of the invention in conjunction with the accompanying figures.

### BRIEF DESCRIPTION OF THE DRAWINGS

The invention will now be described in greater detail with reference to the accompanying diagrams, in which:

FIG. 1 is a schematic diagram of a virtual key system according to one embodiment of the invention;

FIG. 2 is a block diagram of a Telephony Application Server (TAS), one of the components of FIG. 1, according to one embodiment of the invention;

FIG. 3 is a block diagram of the TAS according to another embodiment of the invention;

FIG. 4 is a block diagram of a high-level architecture of software implemented within the TAS of FIG. 2 and FIG. 3 according to one embodiment of the invention; and

FIG. 5 is a block diagram of the business layer of FIG. 4 according to one embodiment of the invention.

### DETAILED DESCRIPTION OF THE PREFERRED EMBODIMENT

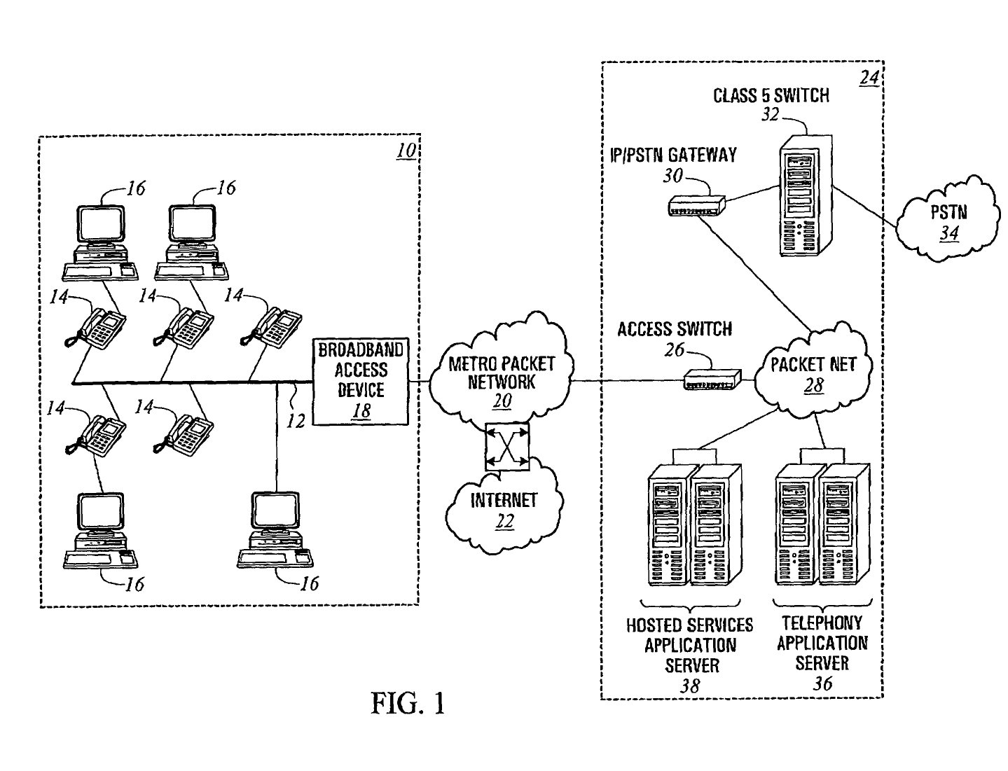

Referring to FIG. 1, a schematic diagram of a virtual key system according to one embodiment of the invention is shown. A customer premises 10 includes a Local Area Network (LAN) 12, such as an Ethernet LAN. The LAN 12 interconnects a plurality of Internet Protocol (IP) telephone sets 14. The IP telephone sets 14 digitize and packetize end user speech, and generate appropriate IP telephony signalling messages. Each of one or more personal computers 16 may be connected to a corresponding IP telephone set 14, and thereby be indirectly connected to the LAN 12. One or more personal computers 16 may be connected directly to the LAN 12. IP telephone sets 14 and personal computers 16 are referred to collectively as end user devices.

The LAN 12 is connected to a broadband access device 18, which provides broadband access to a metro packet network 20. The broadband access may be of any type. As examples, the broadband access may be a Digital Subscriber Line (DSL), coaxial cable, optic fiber, or wireless connection. The broadband access device routes traffic from the LAN 12 through the metro packet network 20 to destinations dependent on the type of traffic. The broadband access device also prioritizes packets, giving a higher priority to voice and voice signalling packets over data packets.

The metro packet network 20 provides communication access to the Internet 22. The metro packet network 20 also provides communication access to a service provider's premises 24 via an access switch 26 located within the service provider's premises 24. It should be noted that the service provider's premises 24 may be a single location, such as a central office, or may be distributed over several locations. The service provider's premises 24 is an abstract delimiter which includes network elements over which the service provider has administrative control and responsibility.

The access switch 26 is connected to a packet network 28. The packet network 28 could be based on Asynchronous Transfer Mode (ATM) or any other packet-based switching known in the art. In addition to serving the customer premises 10, the access switch 26 may provide communication access to additional broadband access devices and customer premises (not shown in FIG. 1). The access switch 26 may connect many customer premises with the packet network 28. For example, if the broadband access device 18 is a DSL modem and the packet network 28 is an ATM network, then the access switch 26 includes many DSL modems, one at the termination point of the subscriber line from each customer premises. Each DSL modem in the access switch 26 is connected to a digital subscriber line access multiplexer (DSLAM). The DSLAM links the DSL lines to a single high-speed ATM line connected to the packet network 28.

The packet network 28 is connected to an Internet by Protocol/Public Switched Telephone Network (IP/PSTN) gateway 30. The IP/PSTN gateway 30 is connected to a traditional class 5 switch 32, such as a DMS-100™ or a 5ESS™, preferably through a T1/T3 link. The class 5 switch 32 is a traditional class 5 switch (as opposed to a softswitch) in that it has a closed architecture, is built on proprietary software, performs circuit-switching and not packet switching, and performs both call control and line/trunk termination within the same hardware. The IP/PSTN gateway 30 communicates with the class 5 switch 32 through a Primary Rate Interface, and converts packetized voice traffic to circuit-switched voice traffic, such as Time Division Multiple Access (TDMA) traffic. The class 5 switch 32 is connected to a PSTN 34.

The packet network 28 is also connected to a Telephony Application Server (TAS) 36. The TAS 36 provides call management services and call features in response to events generated by the end user devices within the customer premises 10 and by the IP/PSTN gateway 30. One of the call features provided by the TAS 36 is an auto attendant. This functionality of the TAS 36, along with the arrangement of network elements within the service provider's premises 24, enables a virtual key system to be operated for the customer without requiring additional equipment at the customer premises 10. Call management services include call set-up and call teardown. Call features may include any combination of auto line select, auto route selection, auto telephone relocation, call coverage, call forward, call pickup group, call queuing, caller ID display, class of service, company directory, conference call, dial by name, direct mail transfer, do not disturb, hands free answer in intercom call, held line reminder, hold, intercom, line in use indicator, line pools, redial, ringing line select, soft keys, speakerphone, speed dial list, TAPI support, and transfer.

By moving call management and call feature functionality from the class 5 switch 32 to the TAS 36, and by incorporating auto-attendant functionality into the TAS 36, a separate directory number need not be provisioned at the class 5 switch 32 for each end user device at the customer premises 10. Directory numbers can be shared by end user devices, in that a particular directory number can be provisioned for an end user device and at least one other end user device. In fact, in many circumstances a single directory number may be provisioned for all end user devices within the customer premises 10, the auto-attendant functionality of the TAS 36 allowing calls to a single directory number to be routed to any end user device within the customer premises 10. This frees directory numbers for use in serving other customers.

The TAS 36 is fully redundant, and may be distributed in that its functionality may be located on separate hardware platforms. In one embodiment, the TAS 36 comprises redundant SUN servers operating under Solaris version 2.8. However, any other servers that offer comparable performance, scalability and reliability could be employed. The TAS 36 is designed to interact with the service provider's order entry, provisioning, billing and fault-management systems (not shown in FIG. 1). Both the IP/PSTN gateway 30 and the TAS 36 can be maintained and monitored through a secure Virtual Private Network connection.

The TAS 36 is designed to support a variety of IP telephone sets 14 from different manufacturers and to operate in conjunction with IP/PSTN gateways 30 from a variety of network equipment providers. As such, proprietary protocols from the IP telephone set manufacturers can be translated and interfaced with the IP/PSTN gateway 30. This is accomplished by means of a device abstraction layer, described below with reference to the software architecture within the TAS 36.

In one embodiment, the packet network 28 is also connected to a hosted services application server 38. The hosted services application server 38 hosts Internet-based application services of interest to a small business, such as website hosting and e-mail. Hypertext Transfer Protocol (HTTP) access to and from the Internet 22 is also available.

In operation the access switch 26 receives packetized data from the broadband access device 18, originating from one of the end user devices in the customer premises 10. Each data packet is routed within the packet network 28 to a particular network element within the service provider's premises 24 as determined from a destination address within the packet, which will depend on a data type of the packet. The data types may be broadly categorized as voice data, telephony signalling data (including call management data and call feature data), provisioning data, and, in one embodiment, hosted service application data.

Voice data includes packetized voice traffic, usually in conformance with the Real-time Transport Protocol (RTP) (defined in Schulzrinne et al., “RTP: A Transport Protocol for Real-Time Applications”, IETF RFC 1889, January 1996), which is to be communicated over the PSTN 34. Voice data is routed to the IP/PSTN gateway 30 where it is converted to circuit-switched voice traffic for transmission through the class 5 switch. Telephony signalling data is routed to the TAS 36, where call management data is used to interact with call management services (such as digit collection) and call feature data is used to interact with call feature services (such as instructions to retrieve voicemail). Hosted service application data are routed to the hosted services application server 38 in order to interact with hosted services, for example, instructions to access e-mail.

Data flow within the virtual key system will now be described with reference to several call events: new IP telephone set configuration, outgoing call set-up and operation, internal call set-up and operation, incoming call setup and operation, and call feature provisioning. When a new IP telephone set 14 is plugged into the LAN 12, the new IP telephone set 19 communicates a Dynamic Host Configuration Protocol (DHCP) (described in R. Droms, “Dynamic Host Configuration Protocol”, IETF RFC 2131, Bucknell University, March 1997) request to a DHCP server (not shown in FIG. 1). The DHCP server leases an IP address to the newly connected IP telephone set. The DHCP server sends a DHCP response to the IP telephone set. The DHCP response includes the IP address of the telephone set and an IP address of the TAS 36. The IP telephone set uses this information to connect to and register with the TAS 36.

When an outgoing call (i.e. a call originating at an IP telephone set 14 within the customer premises 10 and terminating at a non-IP telephone outside the customer premises 10) is initiated, call management data is sent to the TAS 36 indicating that the IP telephone set 14 has gone off-hook. The TAS 36 sends call management data to the IP telephone set 14 instructing the IP telephone set 14 to apply a dial tone. A user dials digits, each of which is sent individually as call management data to the TAS 36. Once the TAS 36 has collected enough digits to route the call, the TAS 36 informs the IP/PSTN gateway 30 of destination digits for the call, using for example the Media Gateway Control Protocol (MGCP) (defined in Arango et al., “Media Gateway Control Protocol (MGCP)”, IRTF REC 2705, October 1999), although other protocols such as the session Initiation Protocol (SIP) (defined in Handley et al., “SIP: Session Initiation Protocol”, IETF RFC 2543, March 1999) can be used. The IP/PSTN gateway 30 then sends a message to the class 5 switch 32 identifying the destination digits.

During the outgoing call, Voice data packets from the IP telephone set 14 are received by the access switch 26 and routed to the IP/PSTN gateway 30 through the packet network 28. The IP/PSTN gateway 30 determines a destination of each voice data packet based on a User Datagram Protocol port through which the voice data packet was received. The IP/PSTN gateway 30 converts the outgoing voice packets to a circuit-switched format (such as TDMA) for transport over the circuit switched route established during call set-up. The IP/PSTN 30 converts incoming speech to voice packets for delivery to the IP telephone set 14.

When an internal call (i.e. a call originating and terminating within the customer premises 10) is initiated, the same procedure as occurs when an outgoing call is initiated is carried out, except that once the TAS 36 has collected enough digits to determine the destination of the call (such as an internal extension number within the customer premises 10) the TAS 36 instructs the called IP telephone set 14 to ring. During the internal call, all voice traffic is peer-to-peer and voice packets remain within the customer premises 10.

When an incoming call (i.e. a call originating from a non-IP telephone outside the customer premises 10 and terminating within the customer premises 10) is initiated, the IP/PSTN gateway 30 passes the dialled digits on to the TAS 36. The TAS 36 determines the IP address of the called IP telephone set 14 or of the automated attendant, given the dialled digits (possibly including an extension number). The TAS 36 also determines whether the called user has activated any call features which indicate that a different IP address should be provided to the IP/PSTN gateway 30. The TAS 36 then instructs the called IP telephone set 14 to ring, or instructs the end user device of the different IP address (for example, a second IP telephone set to which the called user has set up call forwarding) to ring. When the call is completed on a device (for example, the automated attendant answers the call, the called user picks up the handset, or a user of a second IP telephone set to which call forwarding is directing calls picks up the handset, as appropriate) the IP address of the device on which the call terminated is passed to the IP/PSTN gateway 30 so that an audio path can be established. During the incoming call, the IP/PSTN gateway 30 operates in the same way as during an outgoing call, converting outgoing voice packets to circuit-switched format and packetizing incoming speech.

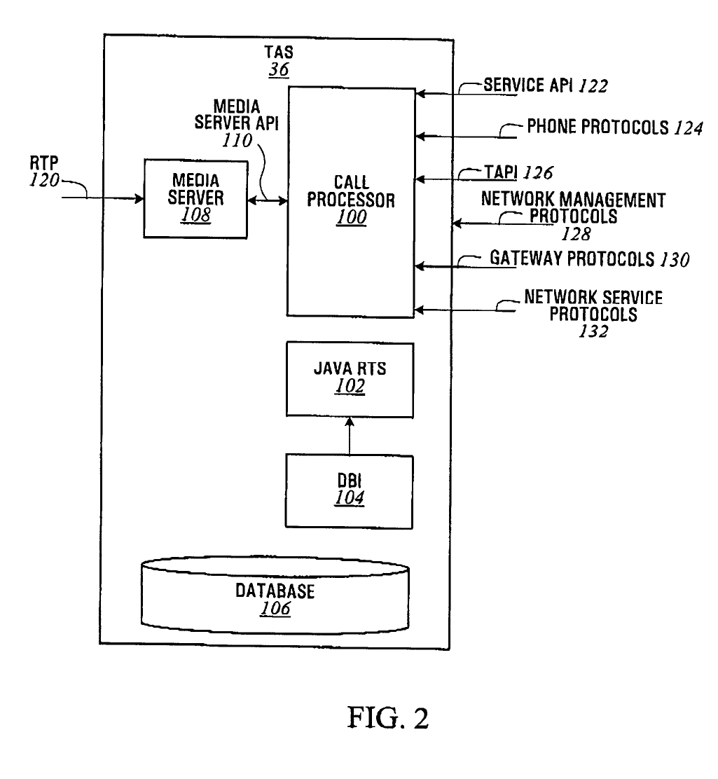

When a user wishes to provision call features for an IP telephone set 14 (e.g. set up a call forward destination for the IP telephone set 14) the user enters commands at the IP telephone set 14, for example by pressing a feature button, and call feature data are transmitted to the access switch 26. The call feature data are routed through the packet network 28 to the TAS 36, which updates the user's call feature settings stored in a database (described below with reference to FIG. 2). In one embodiment the user can also enter commands through a Hypertext Mark-up Language (HTML) interface and HTTP messages are transmitted to the access switch 26 for routing to the TAS 36.

Referring to FIG. 2, a block diagram of the TAS 36 according to one embodiment of the invention is shown. The TAS 36 includes a Call Processor 100, which is a collection of software subsystems that provide call management services and call features. The Call Processor 100 operates in a Java Run-Time System (RTS) context 102 so as to be operable on a variety of platform types. The Call Processor 100 communicates through a database interface 104 with a database 106. The database interface 104 is middleware so as to allow changes to the structure and type of database 106 to be made without requiring changes to the Call Processor 100. The database 106 stores persistent data such as user identifications, passwords, preferences, and call feature settings. The Call Processor 100 communicates with a media server 108 through a media server application programming interface (API) 110. The media server 108 provides audio call features, such as voice-mail, automated attendant, and company directory services.

The TAS 36 interacts with a number of external processes. The media server 108 sends and receives audio data 120 from a user of an IP device, preferably in conformance with the RTP. The Call Processor 100 sends and receives a number of types of messages, including service API messages 122, phone protocol messages 124, telephony API (TAPI) messages 126, network management protocol messages 128, gateway protocol messages 130, and network service protocol messages 132.

Service API messages 122 are received from a service API through which call feature services can be added to the functionality of the TAS 36. This allows third party applications to interact with the TAS 36 to provide remote call features for use by the end user devices. Service API messages 122 are preferably in conformance with the Simple Object Access Protocol (D. Box et al., “Simple Object Access Protocol (SOAP) 1.1”, W3C Note, May 8, 2000) so as to allow generic access to call management components and call feature components of the TAS 36.

Phone protocol messages 124 are received from IP telephone sets 14, and carry information necessary for call management and for interaction with call features. Phone protocol messages 124 are in conformance with the MGCP or other stimulus based protocols.

TAPI messages 126 are received from a personal computer 16 running third party software under Microsoft Windows™ which allows a user to initiate and manage a call. Voice data originates from an IP telephone set 14, but initiation of the call and interaction with call features occurs through a Microsoft Windows™ environment.

Network management protocol messages 128 are received from other network elements in the service provider's premises 24 so that the network elements can be managed. The network management protocol messages 128 are preferably in conformance with the Simple Network Management Protocol (J. Case et al., “A Simple Network Management Protocol (SNMP)”, IETF RFC 1157, May 1990).

Gateway protocol messages 130 are received from the IP/PSTN gateway 30 and allow communication between the TAS 36 and the IP/PSTN gateway 30. The gateway protocol messages 130 are preferably in conformance with the MGCP or with the SIP.

Network service protocol messages 132 are received from Internet-based services provided by the Hosted Services Application server 38. The network service protocol messages 132 are preferably in conformance with the SIP.

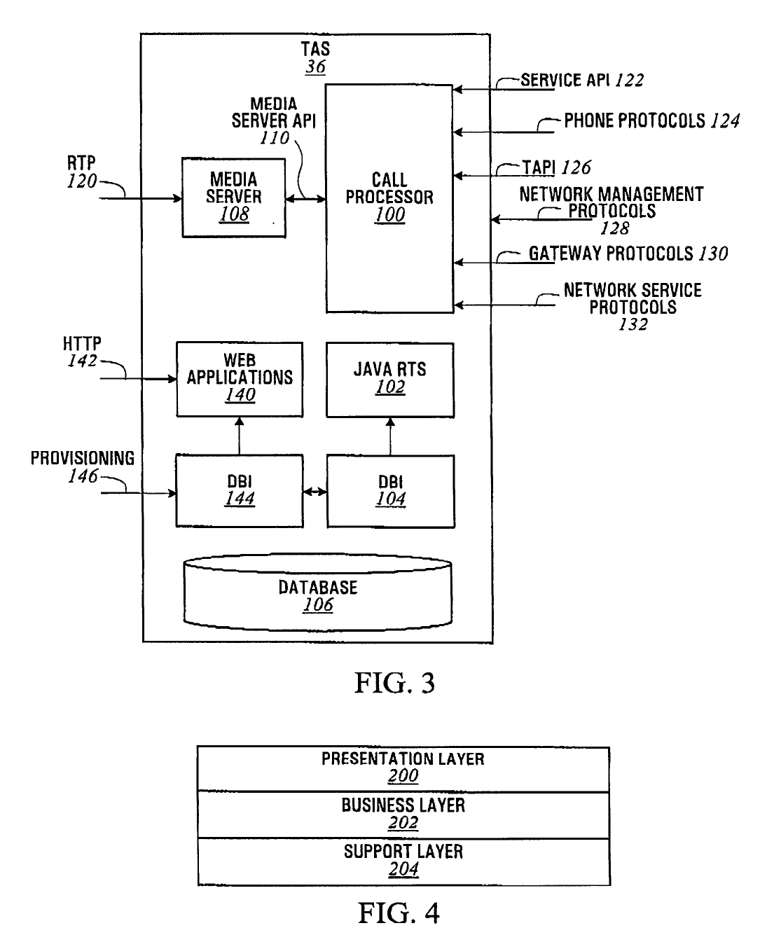

Referring to FIG. 3, a block diagram of the TAS 36 according to another embodiment of the invention is shown. In addition to components present in the embodiment described above with reference to FIG. 2, the TAS 36 includes at least one web application 140 which can be accessed by a user of a personal computer 16 using HTTP messages 142. The at least one web application 140 may include: a user portal, used by end users to configure their IP telephone set 14 and to access call features; a customer administration application, used by an authorized end user to perform customer configuration tasks such as ordering new IP telephone sets and setting user names and extension numbers for IP telephone sets 14 at the customer premises 10; a service provider administration application, used by an administrator of the virtual key system to configure and monitor the virtual key system of the present invention; and a third-party services interface, for allowing a third party to add call features to the system and thereby extend the capabilities of the virtual key system of the present invention.

The at least one web application 140 accesses the database 106 through a second database interface 144 which, like the database interface 104, is middleware so an to allow changes to the structure and type of the database 106 to be made without requiring changes to the at least one web application 140. The database 106 can be provisioned through the second database interface 144 using provisioning messages 146 received from a provisioning API.

As stated above, the TAS 36 may be distributed over more than one hardware platform. In one embodiment a first server includes the database 106, a second server includes the media server 108, a third server includes the web applications 140 and the second database interface 144, and a fourth server includes the call processor 100, the Java RTS context 102, and the database interface 104.

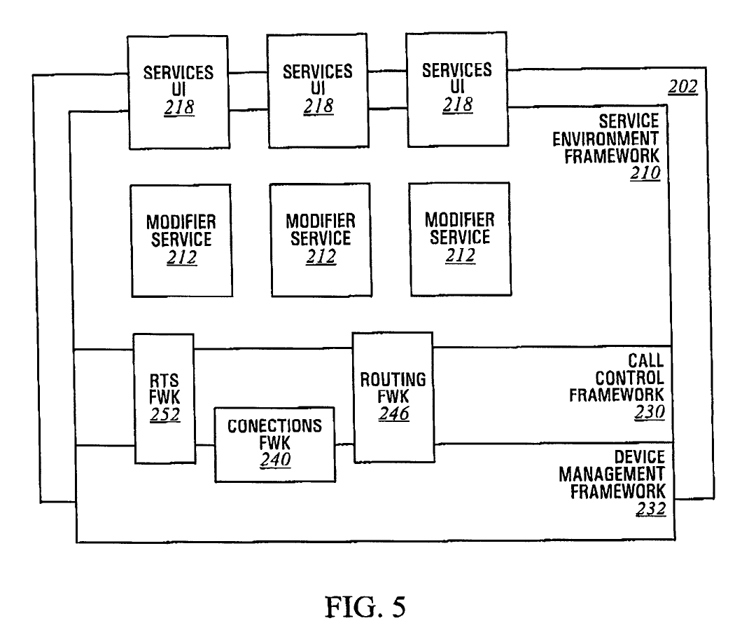

The ability of the TAS 36 to provide call management services and call features may be implemented in any of a number of ways. Referring to FIG. 4, a high-level architecture of call processing software implemented in the call processor 100 of FIG. 2 and FIG. 3 according to one embodiment of the invention is shown. The call processing software includes a presentation layer 200, a business layer 202, and a support layer 204. The presentation layer 200 is responsible for presenting call management services and call features to the user of an end user device through a user interface (UI), such as an HTML-based UI, or an IP telephone set display. The business layer 202 is responsible for implementing the business logic of the TAS 36, one embodiment of which is described in more detail below with reference to FIG. 5.

The support layer 201 is responsible for providing support services, handling communications, interfacing with devices, and accessing data from the database 106. In a preferred embodiment, the support layer 204 includes a device abstraction layer (not shown in FIG. 4). The device abstraction layer abstracts communication with end user devices and with the IP/PSTN gateway 30 by converting hardware-specific events into generic messages for use within the TAS 36. For example, the device abstraction layer interprets end user device-specific events received by the TAS 36 and translates the end-user device-specific events into generic call processing messages for use by other software components within the TAS 36. Generic call processing messages received at the device abstraction layer from other software components within the TAS 36 are sent to a software object representing the particular type of IP/PSTN gateway 30 and are converted into IP/PSTN gateway-specific messages. In this way IP telephone sets 14 using various protocols can be quickly and easily added to the system without requiring changes to the business layer.

Referring to FIG. 5, a more detailed view of the business layer 202 of FIG. 4 according to one embodiment of the invention is shown. The business layer 202 includes a plurality of frameworks, each of which is described below in turn. Each framework is a collection of software components, which may include object classes and more traditional structured routines.

A service environment framework 210 contains the core set of service functionality that provides shared services, such as the call features listed above, to individual calls. The services themselves may be located on the TAS 36 or elsewhere. The service environment framework 210 supports the addition and interaction of call features on a call, and the addition and management of custom telephony services and applications. The service environment framework 210 includes at least one modifier service 212, each of which is a software object representing a call feature. Access by a user to each service is by way of a corresponding service UI 218, which provides communication between the presentation layer 200 and the service environment framework 210. Three modifier services 212 and three corresponding service UIs 218 are shown in FIG. 5 by way of example only. In general, there may be any number of modifier services 212 and corresponding service UIs 218.

A call control framework 230 manages individual calls, as well as providing services to the service environment framework 210 when a service bridges more than one call (for example, merging of calls).

A device management framework 232 provides communication between the service environment framework 210 and the support layer 204 when device-related operations are required in operation of a service. The device management framework 232 includes a device actor for each type of device supported by the virtual key system.

A connections framework 240 is accessed by the call control framework 230 and the device management framework 232. Each call has an audio state, and the connections framework 240 maintains a representation of the audio state of an individual call.

A routing framework 246 is responsible for collecting digits entered by a user, translating the digits according to a dial plan of the user, and routing the call to an appropriate called device.

A Run-Time System (RTS) framework 252 is a cooperative, multi-tasking scheduler for managing other software components. The RTS framework 252 is sully event-driven, and avoids context switching overhead experienced in standard thread-managed systems.

The TAS 36 provides call management services and call features by means of software, the architecture of one embodiment of which is described above with reference to FIG. 4 and FIG. 5. The TAS 36 also allows configuration by users in the customer premises 10 of their personal call feature settings, and configuration by an authorized user in the customer premises 10 (such as an administrator) of customer preferences and settings, through the presentation layer 200. The configuration may be by way of the phone protocol messages 124 of FIG. 2, or by way of HTTP messages 142 of FIG. 4.

What has been described is merely illustrative of the application of the principles of the invention. Other arrangements and methods can be implemented by those skilled in the art without departing from the spirit and scope of the present invention.

1. A system for providing call management services and call features to a plurality of end user devices on a Local Area Network (LAN) within a customer premises, the LAN being in communication with the system through a packet switched broadband network, the system comprising:
a packet network;
an access switch coupled to the packet network and adapted to be coupled to the packet switched broadband network;
an Internet Protocol (IP)/Public Switched Telephone Network (PSTN) gateway coupled to the packet network;
a traditional class 5 switch coupled to the IP/PSTN gateway and providing access to a PSTN, and having at least one directory number provisioned for the customer premises, there being fewer such directory numbers than end user devices; and
a Telephony Application Server (TAS) including an automated attendant and coupled to the packet network, and adapted to provide the call management services and the call features to the end user devices.

2. The system of claim 1 wherein the class 5 switch has exactly one directory number provisioned for the customer premises.

3. The system of claim 1 wherein the IP/PSTN gateway and the class 5 switch communicate through a primary rate interface.

4. The system of claim 1 wherein the call features include audio call features, and wherein the TAS comprises:
a database adapted to store user information;
a media server adapted to provide the audio call features to the end user devices; and
a Call Processor adapted to provide the call management services and the call features to the end user devices.

5. The system of claim 4 wherein the IP/PSTN gateway and the class 5 switch communicate through a primary rate interface.

6. The system of claim 4 wherein the Call Processor comprises:
a presentation layer for presenting the call management services and the call features to the end user devices;
a support layer for providing access to the database and to hardware devices; and
a business layer comprising:
a service environment framework for providing shared services to a call;
a call control framework for managing calls;
a device management framework for providing communication between the service environment framework and the support layer;
a routing framework for collecting and translating dialled digits, and for routing a call to a called device;
a connections framework for maintaining a representation of an audio state of a call; and
a run-time system framework for scheduling and managing software tasks within the TAS.

7. The system of claim 6 wherein the support layer further comprises a device abstraction layer for abstracting communications between the TAS and the end user devices and between the TAS and the IP/PSTN gateway.

8. The system of claim 4 wherein the TAS further comprises at least one web application including a customer administration application for allowing an authorized end user to perform customer configuration tasks.

9. The system of claim 8 wherein the at least one web application further include:
a user portal for allowing end users to configure the end user devices and to access call features;
a service provider administration application for allowing an administrator of the system to configure and monitor the system; and
a third-party services interface for allowing a third party to add call features to the system.

10. The system of claim 1 wherein the call features include audio call features, and wherein the TAS comprises:
a first hardware platform having a database adapted to store user information;
a second hardware platform having a media server adapted to provide the audio call features to the end user devices; and
a third hardware platform having a Call Processor adapted to provide the call management and the call feature services to the end user devices.

11. The system of claim 10 wherein the Call Processor comprises:
a presentation layer for presenting the call management services and the call features to the end user devices;
a support layer for providing access to the database and to hardware devices; and
a business layer comprising:
a service environment framework for providing shared services to a call;
a call control framework for managing calls;
a device management framework for providing communication between the service environment framework and the support layer;
a routing framework for collecting and translating dialled digits, and for routing a call to a called device;
a connections framework for maintaining a representation of an audio state of a call; and
a run-time system framework for scheduling and managing software tasks within the TAS.

12. The system of claim 11 wherein the Call Processor further comprises a device abstraction layer for abstracting communications between the TAS and the end user devices and between the TAS and the IP/PSTN gateway.

13. The system of claim 10 wherein the TAS further comprises at least one web application including a customer administration application for allowing an authorized end user to perform customer configuration tasks.

14. The system of claim 13 wherein the at least one web application further include:
a user portal for allowing end users to configure the end user devices and to access call features;
a service provider administration application for allowing an administrator of the system to configure and monitor the system; and
a third-party services interface for allowing a third party to add call features to the system.

15. The system of claim 1 wherein the TAS further comprises at least one web application including a customer administration application for allowing an authorized end user to perform customer configuration tasks.

16. The system of claim 15 wherein the at least one web application further include:
a user portal for allowing end users to configure the end user devices and to access call features;
a service provider administration application for allowing an administrator of the system to configure and monitor the system; and
a third-party services interface for allowing a third party to add call features to the system.

17. The system of claim 1 further comprising a hosted services application server coupled to the packet network.

18. A Telephony Application Server (TAS) for providing call management services and call features, including audio call features, to a plurality of end user devices, the TAS comprising:
a database adapted to store user information;
a media server adapted to provide the audio call features to the end user devices, including an automated attendant; and
a Call Processor adapted to provide the call management services and the call features to the end user devices.

19. The TAS of claim 18 wherein the Call Processor comprises:
a presentation layer for presenting the call management services and the call features to the end user devices;
a support layer for providing access to the database and to hardware devices; and
a business layer comprising:
a service environment framework for providing shared services to a call;
a call control framework for managing calls;
a device management framework for providing communication between the service environment framework and the support layer;
a routing framework for collecting and translating dialled digits, and for routing a call to a called device;
a connections framework for maintaining a representation of an audio state of a call; and
a run-time system framework for scheduling and managing software tasks within the TAS.

20. The TAS of claim 18 wherein the TAS further comprises at least one web application including a customer administration application for allowing an authorized end user to perform customer configuration tasks.

21. The TAS of claim 20 wherein the at least one web application further include:
a user portal for allowing end users to configure the end user devices and to access call features;
a service provider administration application for allowing an administrator of the system to configure and monitor the system; and
a third-party services interface for allowing a third party to add call features to the system.
